(19) United States
(12) Patent Application Publication
(10) Pub. No.: US 2014/0220950 A1
(43) Pub. Date: Aug. 7, 2014

(54) INFORMATION SYSTEM

(71) Applicant: CHEN-YA HUNG, Kaohsiung City (TW)

(72) Inventor: CHEN-YA HUNG, Kaohsiung City (TW)

(21) Appl. No.: 14/064,000

(22) Filed: Oct. 25, 2013

(30) Foreign Application Priority Data
Feb. 4, 2013 (TW) 102104150

(51) Int. Cl. H04W 8/22

(52) U.S. Cl. CPC H04W 8/22
USPC 455/418

(57) ABSTRACT

An information system is located in a mobile communication device which includes a receiver and a processor. The processor contains a disconnect program linked to a communication processing program in the processor. When the receiver receives a special command the disconnect program is activated and the communication processing program is notified to suspend communication operation, therefore can save communication fare, and also prevent conversation from being overheard by unrelated people to avoid causing unnecessary concerns.

### FIELD OF THE INVENTION

The present invention relates to mobile communication and particularly to an information system with an added disconnect program to disconnect mobile communication.

### BACKGROUND OF THE INVENTION

A conventional mobile communication device 1, referring to FIGS. 1 and 2, comprises at least a receiver 2, a speaker 3, a processor 4 which bridges the receiver 2 and speaker 3 and contains at least one communication processing program 5, and also a disconnect button 6 which can be a physical one or virtual. The present invention takes the physical disconnect button 6 as an example for discussion.

In general when a user makes call through the mobile communication device 1 he/she often has to hold the device 1 with one hand. When the call is finished the user has to push the disconnect button 6 with other hand. It is inconvenient. In the event that the other hand is in use such as opening a door or carrying goods, the communication cannot be disconnected immediately, and the communication fare increases rapidly by seconds, or the conversation of the caller in work or meeting could be overheard by the receiving party or vice versa, this could cause unnecessary concerns.

Or, when the user is making call with the mobile communication device 1 through a connecting a Bluetooth earpiece (not shown in the drawings), he/she can push the disconnect button 6 with the spared hand when the call is finished. But the user generally uses the Bluetooth earpiece to make call during driving or riding a motorcycle, or working or meeting, with both hands occupied, hence cannot immediately push the disconnect button 6, then the concerns mentioned above, such as rapid increase of communication fare and infringing of privacy (such as conversation overheard by non-related people), also are created.

Hence how to overcome the aforesaid problems by suspending conversation of the mobile communication device 1 immediately to save the communication fare and maintain desired privacy without the conversation overheard by unrelated people is an issue yet to be resolved.

### SUMMARY OF THE INVENTION

The primary object of the present invention is to provide a technique to activate a disconnect program when the receiver of a mobile communication device receives a special command, and inform a communication processing program to disconnect communication of the mobile communication device, thereby to save communication fare and prevent conversation from being overheard by unrelated people.

To achieve the foregoing object the present invention provides an information system that is located in a mobile communication device which includes at least a receiver and a processor connected to the receiver and contained at least one communication processing program. The invention provides features including: a disconnect program which can be located in the processor or connected to the communication processing program to suspend operation of the communication processing program.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional mobile communication device.

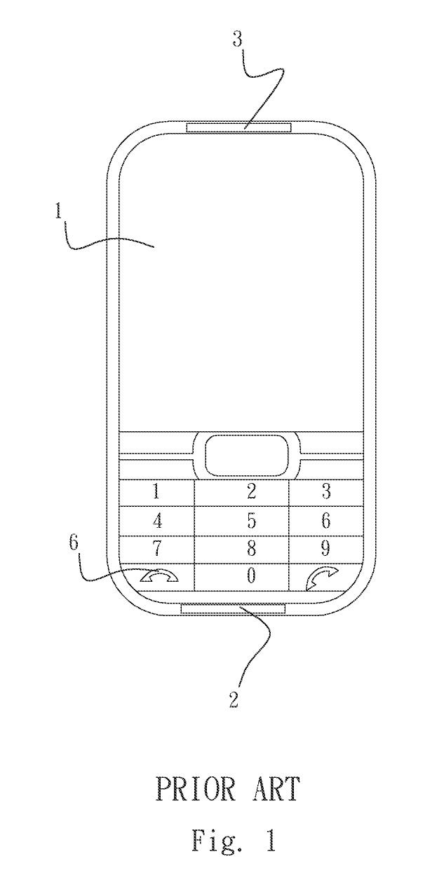

FIG. 2 is a block diagram of a conventional mobile communication device.

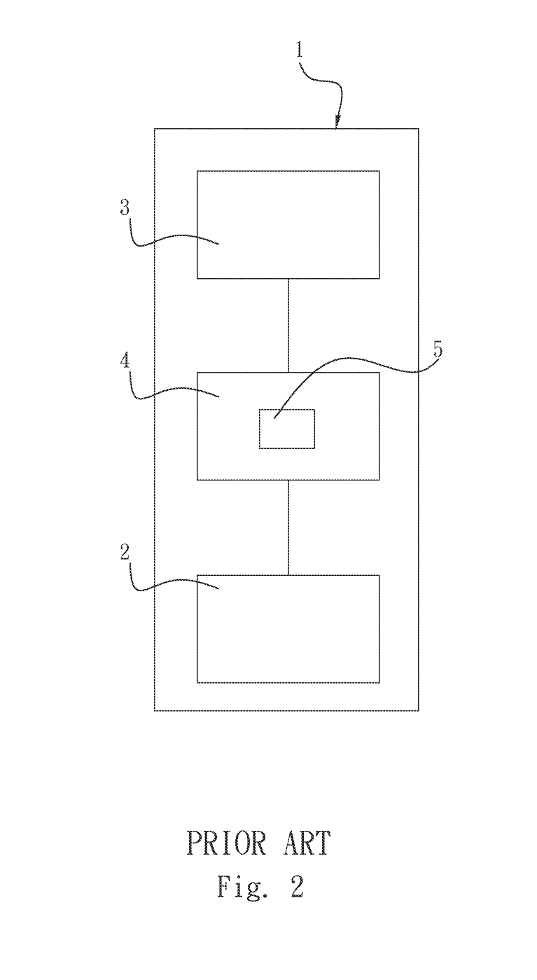

FIG. 3 is a block diagram of an embodiment of the invention.

FIG. 4 is a process flowchart of an embodiment of the invention

### DETAILED DESCRIPTION OF THE PREFERRED EMBODIMENT

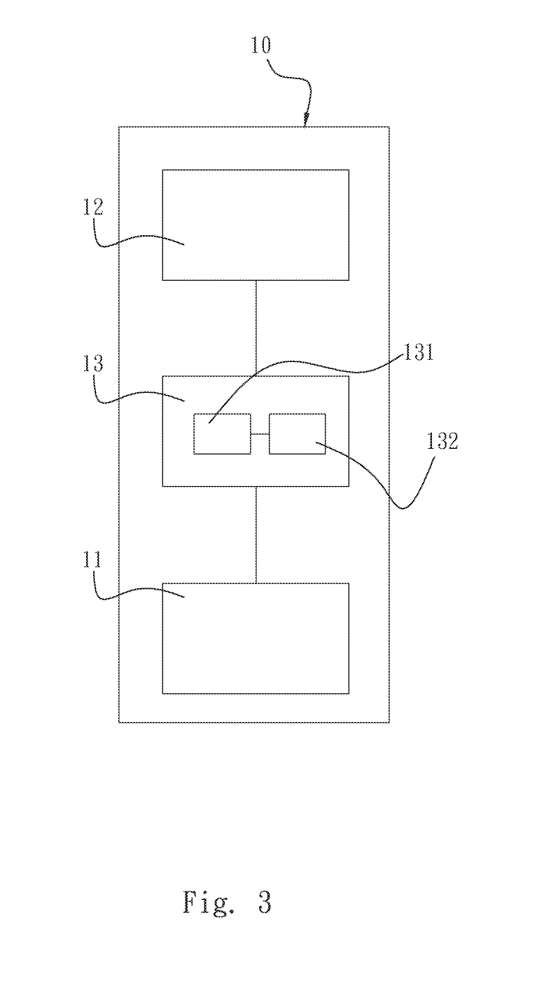

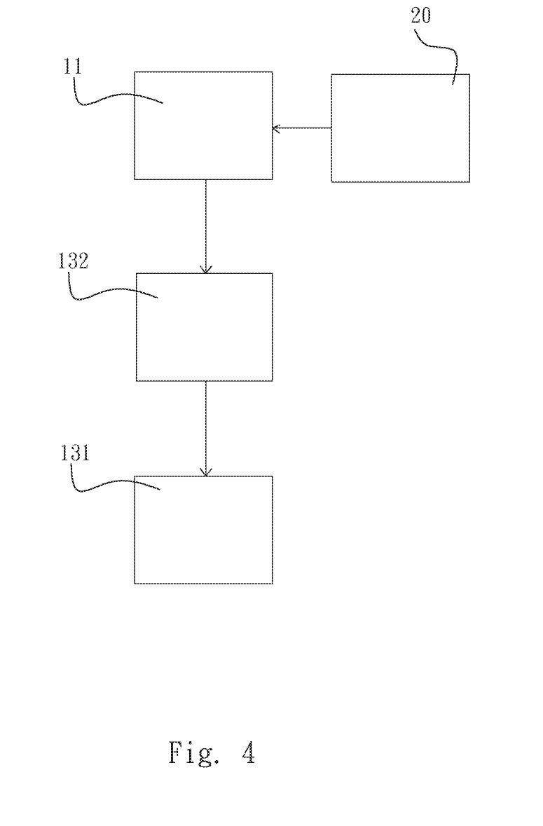

Please referring to FIGS. 3 and 4, the present invention mainly is located in a mobile communication device 10 which includes at least a receiver 11, a speaker 12 and a processor 13 which bridges the receiver 12 and speaker 13 and also contains at least one communication processing program 131, and a disconnect program 132 which can be located in the processor 13 or connected to the communication processing program 131. The disconnect program 132 contains a preset special command 20. When the receiver 11 receives the special command 20 made in a preset language, it is sent to the processor 13 to activate the contained disconnect program 132, thereby suspend operation of the communication processing program 131 and also suspend conversation of the mobile communication device 10, and make the receiver 11 unable to receive sound.

In addition, the special command 20 can be bye-bye, good bye, or other formats set by user.

Also referring to FIGS. 3 and 4, through the technique of the invention set forth above, when the mobile communication device 10 is used by a user for making conversation, whether through a Bluetooth earpiece or with spare hands, once the conversation is finished, the user needs only to speak the special command 20 in the preset language, such as bye-bye, good bye, the special command 20 is sent to the processor 13 to activate the disconnect program 132 to suspend operation of the communication processing program 131, and also make the receiver 11 unable to receive sound at the same time.

Thus, whether the user is driving a car or riding a motorcycle, or during work or meeting, with both hands occupied, he/she needs only to say the special command 20 in the preset language such as bye-bye, good bye, 88 or 881, the communication of the mobile communication device 10 can be immediately suspended, hence can save communication fare, and also avoid conversation in work or meeting from being overheard by unrelated people, therefore does not cause unnecessary concerns.

What is claimed is:

1. An information system located in a mobile communication device which includes at least a receiver and a processor connected to the receiver and contained at least one communication processing program, comprising a disconnect program which is located in the processor and linked to communication processing program to suspend operation of the communication processing program.

2. The information system of claim 1, wherein the disconnect program contains a special command which is receivable by the receiver and sent to the processor to activate the disconnect program to suspend operation of the communication processing program.

3. The information system of claim 2, wherein the special command is made in a preset language.

4. The information system of claim 2, wherein the special command is selected from the group consisting of bye-bye, good bye.

5. The information system of claim 2, wherein the special command is set by users.
